(19) United States
(12) Patent Application Publication
(10) Pub. No.: US 2007/0148335 A1
(43) Pub. Date: Jun. 28, 2007

(54) Method of manufacturing electrode for electrochemical capacitor and apparatus for manufacturing electrode for electrochemical capacitor

(75) Inventors: Hideki Tanaka, Tokyo (JP); Kazuo Katai, Tokyo (JP)

Correspondence Address: OLIFF & BERRIDGE, PLC, P.O. BOX 19928, ALEXANDRIA, VA, 22320, US

(73) Assignee: TDK CORPORATION, TOKYO (JP)

(21) Appl. No.: 11/645,068

(22) Filed: Dec. 26, 2006

(30) Foreign Application Priority Data
Dec. 27, 2005 (JP) P2005-374044

(51) Int. Cl. B05D 5/12

(52) U.S. Cl. 427/79

(57) ABSTRACT

An apparatus comprises a coating portion which forms, on a collector, a coated film comprising porous particles, a binder which binds the porous particles, and a solvent which dissolves the binder, a hot-air drying portion which forms a polarizable electrode layer by hot-air drying of the coated film, and an infrared ray drying portion which performs infrared ray drying of the polarizable electrode layer. By this means, solvent remaining after hot-air drying can be efficiently removed. Hence hot-air drying can be performed gently, and as a result, binder movement and similar can be prevented. Moreover, because infrared ray irradiation is performed in a state in which drying has been performed to some extent, bumping of solvent does not occur.

### BACKGROUND OF THE INVENTION

1. Field of the Invention

The present invention relates to a method of manufacturing electrodes for an electrochemical capacitor and to an apparatus for manufacturing electrodes for an electrochemical capacitor, and in particular relates to a method and apparatus for manufacturing electrodes for an electrochemical capacitor, formed by coating of a polarizable electrode layer comprising porous particles.

2. Description of the Related Art

In recent years there has been much interest in electrochemical devices such as electric double-layer capacitors for use as batteries which afford comparatively large capacities in a compact size and with light weight An electric double-layer capacitor does not utilize a chemical reaction as in the case of ordinary secondary batteries, but instead is a battery type which directly accumulates charge on electrodes, and so has the feature of enabling extremely rapid charging and discharging. Applications which exploit this feature are envisioned in, for example, backup power supplies for portable equipment (compact electronic equipment) and similar, and as auxiliary power supplies for electric vehicles and hybrid vehicles; and various studies are being conducted to improve the performance of such batteries.

The basic construction of an electric double-layer capacitor comprises a pair of collectors in which polarizable electrode layers are formed, the space between which is filled with an electrolytic solution, with separators intervening. The simplest method for forming the polarizable electrode layers on the collectors is a lamination method in which the electrode layer and the collector are bonded; but this method is attended by the problem of difficulty in improving productivity.

In order to resolve this problem, it is preferable that, rather than lamination of collectors and polarizable electrode layers, coating of the collector with a polarizable electrode layer coating liquid is employed, so that by drying this coating liquid, a polarizable electrode layer is formed on the collector. In this case, it is important that the solvent be removed sufficiently by drying, in order to obtain the desired electrical characteristics.

The simplest method of removing solvent through drying is by hot-air drying. However, if hot-air drying is performed, drying occurs from the surface portion of the coated film, and so movement of solvent from the collector side to the surface side occurs within the coated film. This is accompanied by movement toward the surface side of binder which is dissolved by the solvent, and consequently there is the problem that the distribution of the binder becomes uneven, and the quality of the electrode is degraded.

In order to resolve this problem, after drying gently to a certain degree using hot-air drying, complete drying using a vacuum oven may be performed. However, when using this method a vacuum oven is employed in batch processing to dry electrodes, so that production efficiency is sharply reduced. Moreover, in the form of a roll of raw material, adequate drying in a vacuum oven is not possible, and it is necessary to cut out the raw material to a prescribed size and arrange the cutout electrode pieces within the vacuum oven, so that there is the problem tat productivity is greatly reduced.

### SUMMARY OF THE ION

In Japanese Patent Laid-pen No. 2001-307716, a method is disclosed of drying to remove solvent by means of infrared irradiation. By means of this method, the coated film is heated substantially uniformly, so that movement of binder and similar tends not to occur. However, in this method, there is the problem that bumping may occur within the coated film, in which case the coated film is destroyed. Bumping occurs less readily if the infrared irradiation energy is reduced sufficiently, but in this case an extremely long time is required for drying.

On the other hand, though not related to the manufacture of electrodes for electrochemical capacitors, in Japanese Patent Laid-open No. 2001-176502 and Japanese Patent Laid-open No. 2002-170556, methods are disclosed for hot-air drying after preliminary drying by infrared irradiation of a coated film By means of such methods, drying can be performed comparatively efficiently; but because infrared irradiation is performed while the coated film contains a large amount of solvent, similarly to the method of Japanese Patent Laid-open No. 2001-307716, there is the problem that bumping tends to occur. However, in contrast with secondary batteries and other devices, the constituent materials of polarizable electrode layers such as those in electric double-layer capacitors comprise porous particles, and when a very large number of fine holes exist as a result, drying to eliminate solvent is more difficult, and it is difficult to perform drying without the occurrence of bumping.

This invention was devised in order to resolve such problems, and has as an object the provision of a method of manufacture of electrodes for electrochemical capacitors and an apparatus for the manufacture of electrodes for electrochemical capacitors, enabling efficient drying and elimination of solvent contained in coated film, without the occurrence of film destruction due to bumping.

A method of manufacturing electrodes for electrochemical capacitors of this invention is characterized in comprising a first step of forming, on a collector, a coated film comprising porous particles, a binder which binds the porous particles, and a solvent which dissolves the binder, a second step of forming a polarizable electrode layer by hot-air drying of the coated film; and a third step of infra ray drying of the polarizable electrode layer.

In this invention, it is preferable that in the third step, the polarizable electrode layer be irradiated with infrared rays while applying hot air.

Further, in a method of manufacturing electrodes for electrochemical capacitors of this invention, it is preferable that after performing the second step, and before performing the third step, a fourth step, of roller-pressing the polarizable electrode layer, be comprised. In this case, it is more preferable that the first step, second step, and fourth step be performed continuously. Further, it is in particular preferable that the fourth step be a step of roller-pressing using a linear pressure of less than 100 kgf/cm while heating the polarizable electrode layer.

An apparatus for manufacturing electrodes for electrochemical capacitors of this invention is characterized in comprising coating means for forming, on a collector, a coated film comprising porous particles, a binder which binds the porous particles, and a solvent which dissolves the binder, hot-air drying means, for forming a polarizable electrode layer by hot-air drying of the coated film; and infrared drying means, for performing infrared ray drying of the polarizable electrode layer.

By means of this invention, infrared irradiation is performed after performing hot-air drying, so that solvent remaining after hot-air drying can be efficiently removed. Consequently hot-air drying can be performed gently, and consequently binder movement and similar can be prevented. Moreover, infrared irradiation is performed in a state of being dried to a certain extent, so that bumping of solvent does not occur. As a result, good-quality electrodes for electrochemical capacitors can be man y efficiently.

### BRIEF DESCRIPTION OF THE DRAWINGS

FIG. 1 is schematic diagrams (a) and (b) showing the construction of an electrode for an electric double-layer capacitor in a preferred aspect of the invention;

FIG. 2 is a schematic diagram used to explain the method of preparation of coating liquid L1;

FIG. 3 is an oblique summary view showing in enlargement the vicinity of a coating portion 110;

FIG. 4 is used to explain a method of cutting out an electrode 10 for an electric double-layer capacitor from a stacked member 20, in which (a) is a summary plane view of a stacked member 20 cut to a prescribed size, (b) is a summary plane view of the stacked member 20 from which an electrode 10 for an electric double-layer capacitor has been cut, and (c) is a summary plane view of the cut-out electrode 10 for an electric double-layer capacitor, and,

FIG. 5 is a schematic diagram used to explain a method of manufacture of an electric double-layer capacitor using electrodes 10 for an electric double-layer capacitor.

### DESCRIPTION OF THE PREFERRED EMBODIMENTS

Below, preferred aspects of the invention are explained in detail, referring to the attached drawings.

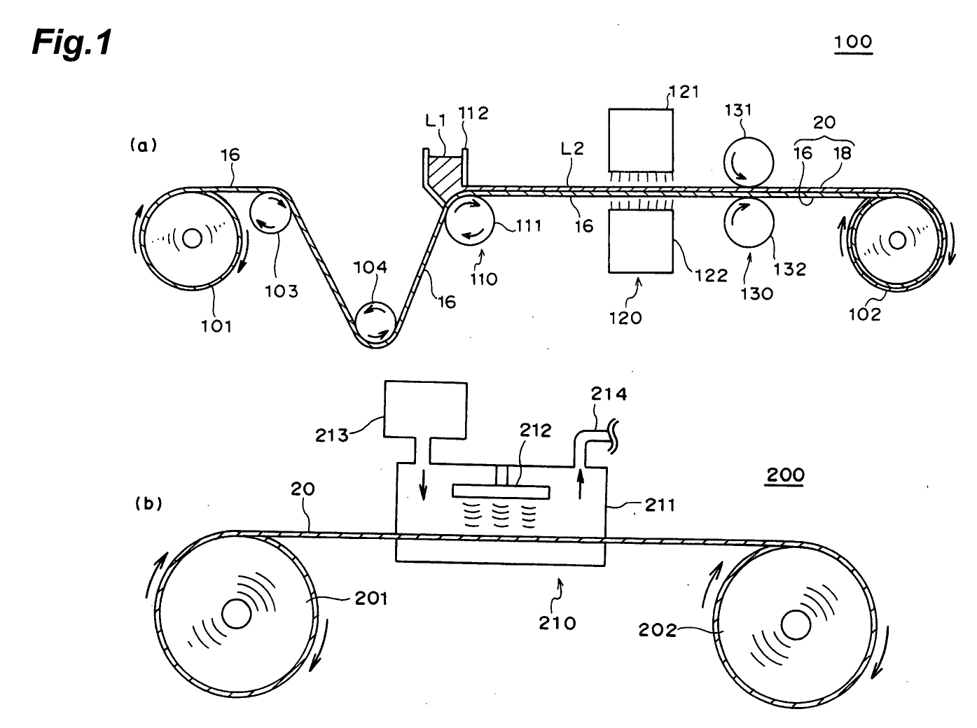

In FIG. 1, (a) and (b) are summary diagrams showing the construction of an apparatus to manufacture electrodes for electric double-layer capacitors in a preferred aspect of the invention. The apparatus to manufacture electrodes for electric double-layer capacitors of this aspect comprises the first-stage portion 100 shown in (a) of FIG. 1, and the second-stage portion 200 shown in (b) of FIG. 1.

As shown in (a) of FIG. 1, the first-stage portion 100 comprises a feeder roll 101, around which is wound a strip-shape collector 16 and a takeup roll 102, which winds and takes up a stacked member 20 comprising the collector 16 and polarizable electrode layer 18 by rotating at a prescribed speed, as well as, provided between the feeder roll 101 and the takeup roll 102, a coating portion 110, a hot-air drying portion 120, and a roller-pressing portion 130, in this order. In this way, the first-stage portion 100 of the apparatus to manufacture electrodes for electric double-layer capacitors of this aspect is configured with the coating portion 110, hot-air drying portion 120, and roller-pressing portion 130 arranged in order from upstream (the feeder roll 101) to downstream (the takeup roll 102).

On the other hand, as shown in (b) of FIG. 1, the second-stage portion 200 comprises a feeder roll 201 onto which is wound the strip-shape stacked member 20, a takeup roll 202 which takes up the stacked member 20, and, provided between the feeder roll 201 and takeup roll 202, an i ray drying portion 210. The feeder roll 201 of the second-stage portion 200 is the same as the takeup roll 102 of the first-stage portion 100. That is, after manufacturing the takeup roll 102 by means of the first-stage portion 100, this is transported to the second-stage portion 200, and used as the feeder roll 201 in the second-stage portion 200.

Below, each of the elements comprised by the apparatus for manufacture of electrodes for electric double-layer capacitors is explained in detail.

First, the first-stage portion 100 is explained.

The coating portion 110 is a portion used to coat the surface of the collector 16 with a coating liquid L1, which is the material of the polarizable electrode layer 18, that is, a portion used to perform the coating process. The coating portion 110 comprises a backup roller 111, and a knife coater (electrode coating means) 112 to coat the surface of the collector 16, curved due to the backup roller 111, with the coating liquid L1. As shown in FIG. 1, the collector 16 supplied from the feeder roll 101 is transported to the coating portion 110 via the guide roller 103 and tension roller 104, and by this means, a coated film L2, which later becomes the polarizable electrode layer 18, is formed on one surface of the collector 16. In this aspect, the feeder roll 101, takeup roll 102, guide roller 103, and tension roller 104 are comprised by the transport means of the collector 16.

The electrode coating means 112 which applies the coating liquid L1 is not limited to the knife coating method, and any of the various well-known coating methods can be used without limitation. For example, the extrusion nozzle method, extrusion lamination method, doctor blade method, gravure roller method, reverse roller method, applicator coating method, kiss coating method, bar coating method, screen printing, or other methods can be used.

No limitations in particular are placed on the material of the collector 16 so long as the material is a good conductor sufficiently capable of moving charge to the polarizable electrode layer 18, and collector materials used in well-known electric double-layer capacitor electrodes, such as for example aluminum (Al), can be used. No limitations in particular are imposed, but it is preferable that the surface of the collector 16 be roughened; by this means, adhesion of the collector 16 and the polarizable electrode layer 18 can be improved. No limitations in particular are imposed on the means of roughening the surface of the collector 16, but roughening can be performed by chemical etching using an acid or another reagent

It is preferable that the etch depth be set to approximately 3 to 7 μm. This is because if the etching is too shallow, almost no advantageous result in improving adhesion is obtained, whereas if the etching is too deep, it becomes difficult to apply a uniform coating of the polarizable electrode layer 18. There is no need in particular to roughen the rear surface of the collector 16, but as explained below, when polarizable electrode layers 18 are formed on both surfaces of the collector 16, it is preferable that both surfaces of the collector 16 be roughened.

No particular limitations are placed on the thickness of the collector 16 either, but in order to render more compact the electric double-layer capacitors manufactured, it is preferable that the thickness be set as thin-as possible, within the limits for ensuring adequate mechanical strength. Specifically, when using aluminum (Al) as the material of the collector 16, it is preferable that the thickness be set to 10 μm or greater and 100 μm or less, and still more preferable that the thickness be 15 μm or greater and 50 μm or less. If the thickness of a collector 16 comprising aluminum (Al) is set within this range, then the electric double-layer capacitors ultimately manufactured can be made more compact, while securing adequate mechanical strength.

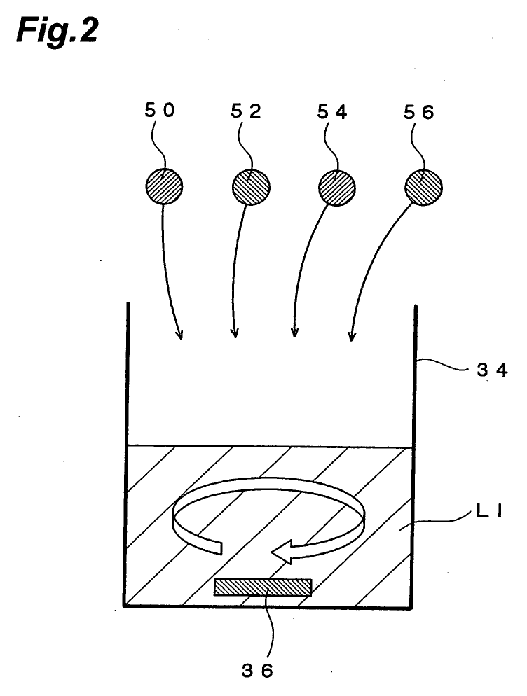

The coating liquid L1 is the liquid material of the polarizable electrode layer 18, and can be prepared by the following method. First, as shown in FIG. 2, porous particles 50, the binder 52, solvent 54, and when necessary a conductive agent 56 are added to a mixing device 34 comprising a stirring portion 36, and the coating liquid L1 is prepared by stirring. It is preferable that preparation of the coating liquid L1 comprise a kneading operation and/or a dilution mixing operation. Here, “kneading” means to knead the material together by mixing with the liquid in a state of comparatively high viscosity, and “dilution mixing” means to add further solvent and similar to the kneaded liquid, kneading together in a state of comparatively low viscosity. No limitations in particular are imposed on the time for these operations or on the temperate at the time of the operations; but from the standpoint of obtaining a uniformly dispersed state, it is preferable that the kneading time be from 30 minutes to two hours approximately, and that the temperature during kneading be approximately 40 to 80° C., and that the dilution mixing time be approximately one to five hours and that the temperature during dilution mixing be approximately 20 to 50° C.

As the porous particles 50 comprised by the coating liquid L1, no limitations in particular are imposed so long as the porous particles have electron conduction properties contributing to the accumulation and discharge of electric charge, and for example activated carbon in particle or fiber form, which has been subjected to activation treatment, or a similar material can be used As the activated carbon, phenolic active carbon, coconut shell activated carbon, and similar can be used. It is preferable that the average particle size of the porous particles be from 3 to 20 μm; it is preferable that the BET specific surface area, determined from the nitrogen adsorption isotherm using the BET adsorption isotherm equation, be 1500 m²/g or higher, and more preferably from 2000 to 2500 m²/g. By using such porous particles 50, a high volume capacity can be obtained.

The binder 52 comprised by the coating liquid L1 is a binder capable of binding the above porous particles 50; for example, polytetrafluoroethylene (PTFE), polyvinylidene fluoride (PVDF), fluoro rubbers, and other fluorine-containing binders can be used. This is because, due to the bonding energy difference between C—F and C—H, cellulose binders and acrylic binders are inferior to fluoride binders with respect to electrochemical properties. Among fluoride binders, it is preferable tat a fluoro rubber be used. This is because if a fluoro rubber is used, sufficient binding of porous particles is possible even when a small amount is comprised, so that the coated film strength of the polarizable electrode layer 18 can be improved, and because the size of the double-layer interface is increased, so that volume capacity can also be increased In addition, fluoro rubbers are electrochemically stable.

As fluoro rubbers, for example, vinylidene fluoride-hexafluoropropylene-tetrafluoropropylene (VDF-FEP-TFE) copolymers, vinylidene fluoride-hexafluoropropylene (VDF-HFP) copolymers, vinylidene fluoride-pentafluoropropylene (VDF-PFP) copolymers, vinylidene fluoride-pentafluoropropylene-tetrafluoroethylene (VDF-PFP-TFE) copolymers, vinylidene fluoride-perfluoromethylvinyl ether-tetrafluoroethylene (VDF-PFMVE-TFE) copolymers, vinylidene fluoride-chlorotrifluoroethylene (VDF-CTFE) copolymers, ethylene-tetrafluoroethylene copolymers, propylene-tetrafluoroethylene copolymers, and similar can be used. Among these, fluoro rubbers resulting from copolymerization of at least two polymers selected from among a group comprising VDF, HFP, and TFE are preferable; and in particular, due to tendencies for further improvement of adhesive properties and resistance to chemicals, VDF-HFP-TFE copolymers, obtained by copolymerization of three polymers in the above group, are particularly preferable.

As the solvent 54 comprised by the coating liquid L1, no limitations in particular are imposed so long as the solvent is capable of dissolution or dispersion of the binder 52; for example, NMP (n-methyl-2-pyrolidone) or similar can be used. It is preferable that a solvent mixture be used, combining methyl ethyl ketone (MEK), methyl isobutyl ketone (MIBK), or another ketone solvent or other good solvent, with propylene carbonate, ethylene carbonate, or another poor solvent It is preferable that the quantity of the solvent 54 blended be 200 to 400 parts by mass per 100 parts by mass of all solid components in the coating liquid L1.

Further, it is preferable that a conductive agent 56 be added as necessary to the coating liquid L1. No limitations are imposed on the conductive agent 56 other than having electron conduction properties enabling adequate promotion of movement of electric charge between collector 16 and polarizable electrode layer 18; for example, it is preferable that carbon black or graphite be used.

As carbon black, for example, acetylene black, ketjen black, furnace black, or similar can be used; among these, it is preferable that acetylene black be used It is preferable that the average particle size of the carbon black be from 25 to 50 nm; it is preferable that the BET specific surface area be 50 m²/g or higher, and still more preferably from 50 to 140 m²/g.

As graphite, for example, natural graphite, artificial graphite, expanding graphite, and similar can be used; in particular, it is preferable that artificial graphite be used. It is preferable that the average particle size of the graphite be 4 to 6 μm, and it is preferable that the BET specific surface area be 10 m²/g or higher, and more preferably still from 15 to 30 m²/g.

It is preferable that the quantity of porous particles 50 comprised in the coated liquid L1 be set such that the quantity of porous particles 50 comprised after forming the polarizable electrode layer 18 is from 84 to 92 mass % with reference to the total quantity of the polarizable electrode layer 18. It is preferable that the quantity of binder 52 comprised be set such that the quantity of binder 52 comprised after forming the polarizable electrode layer 18 is from 6.5 to 16 mass % with reference to the total quantity ofthe polari ale electrode layer 18. In particular, it is preferable that after formation of the polarizable electrode layer 18, with reference to the total quantity of the polarizable electrode layer 18, the porous particles 50 be 84 to 92 mass percent, the binder 52 be 6.5 to 16 mass percent, and that the conductive assistant 56 be 0 to 1.5 mass percent.

The hot-air drying portion 120 is a portion which hardens the coated film L2 by causing the solvent 54 comprised within the coated film L2 to be evaporated to some extent In an apparatus for manufacture of electrodes for electric double-layer capacitors of this aspect, this portion comprises two hot-air drying devices 121, 122, positioned so as to enclose the collector 16. These hot-air drying devices 121, 122 cause evaporation to some extent of the solvent 54 comprised by a coated film L2 by heating; by this means, the coated film L2 is hardened, resulting in the polarizable electrode layer 18.

Hardening of the coated film L2 using the hot-air drying portion 120 (formation of the polarizable electrode layer 18) need not be performed to the extent to which nearly all solvent 54 is removed, and it is sufficient that hardening of the coated liquid L2 be performed to an extent enabling subsequent roller-pressing and take-up. Hence compared with methods of the prior art in which solvent is removed solely by hot-air drying, the hot-air drying can be completed in a short amount of time. Specifically, it is preferable that drying be performed at 70 to 130° C. for from 0.1 to 5 minutes. In this way, drying is performed comparatively gently using the hot-air drying portion 120, so that movement of solvent 54 within the coated film is suppressed. Hence unevenness in the distribution of the binder 52 tends not to occur.

By means of the above processes, a polarizable electrode layer 18 is formed on a surface of a collector 16; in this state, however, the density of the polarizable electrode layer 18 is low, and in this state a high volume capacitance cannot be obtained The density of the polarizable electrode layer 18 after drying, while depending on the size of the porous particles 50, is approximately 0.5 to 0.6 g/cm³.

The roller-pressing portion 130 is a portion which compresses the polarizable electrode layer 18 so as to raise the volume capacitance. In the apparatus for manufacture of electrodes for electric double-layer capacitors of this aspect, a first roller 131, positioned on the side of the polarizable electrode layer 18, and a second roller 132, positioned on the side of the collector 16, are comprised, and by means of these rollers 131, 132, the stacked member 20 is subjected to roller-pressing, to compress the polarizable electrode layers 18 comprised by the stacked member 20.

In this aspect, heaters are incorporated within the rollers 131 and 132, and by this means the roller-pressing portion 130 can heat the polarizable electrode layer 18 while performing roller-pressing. The heating temperature is controlled by a control portion 133 comprised by the roller-pressing portion 130; by this means, the heated temperature of the polarizable electrode layer 18 can be kept at a desired temperature. Heating of the polarizable electrode layer 18 is performed in order to soften the binder 52 comprised by the polarizable electrode layer 18.

Upon completion of this roller-pressing, the stacked member 20 is taken up by the takeup roll 102.

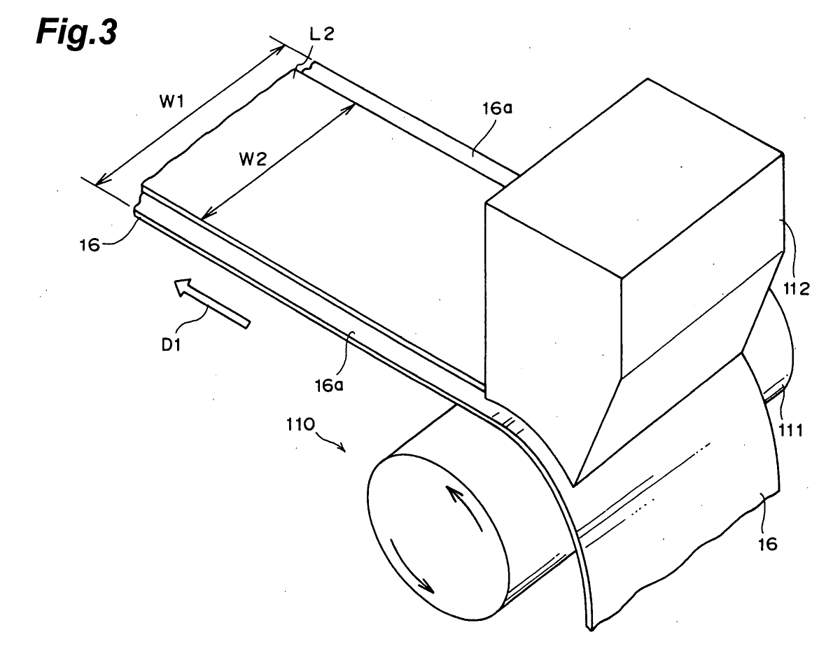

FIG. 3 is an oblique summary view showing in enlargement the vicinity of the coating portion 110.

As shown in FIG. 3, the knife coater 112, comprised by the coating portion 110, forms a coated film L2 of prescribed width to become the polarizable electrode layer 18 on the strip-shape collector 16 transported in the length direction D1, such that uncoated regions 16a remain at the edge portions on both sides in the width direction of the collector 16. That is, if the width of the collector 16 is W1 and the width of the coated film L2 is W2, then the relation between the two is set to W1>W2, and by this means, the coated film L2 is formed substantially in the center portion on the collector 16 which passes the coating portion 110, leaving uncoated regions 16a.

Hence when the roller-pressing portion 130 is used to perform roller-pressing of the stacked member 20, pressure is applied to only the region of the collector 16 onto which the polarizable electrode layer 18 has been coated, and almost no pressure is applied to uncoated regions 16a. Consequently only the region of the collector 16 on which the polarizable electrode layer 18 is formed is rolled, and so the higher the linear pressure applied by the rollers 131 and 132, the grater are the wrinkles occurring in the collector 16 after roller-pressing.

In general, such wrinkles are tolerated if the rate of elongation (the amount of deformation due to roller pressing) in the region of the collector 16 in which the polarizable electrode layer 18 is formed is 1% or lower, but when elongation exceeding 1% occurs, it may be difficult to take up the stacked member using the takeup roll 102, and product reliability may be reduced.

In consideration of this point, in this aspect the linear pressure at the roller-pressing portion 130 is set to be less than 100 kgf/cm. In the prior art, it has been though that sufficient compression was not possible at such low pressures; but in this invention, by performing roller-pressing while heating the polarizable electrode layer 18, compression is made possible at such low pressures. That is, when the binder 52 is softened through heating, the binder 52 can easily permeate the fine holes in the porous particles 50, and as a result, the density of the polarizable electrode layer 18 can be greatly increased even by low-pressure pressing at less than 100 kgf/cm.

It is preferable that the heating temperature be set as high as possible while remaining lower than the heat-resistance temperature of the binder 52; specifically, when the heat-resistance temperature of the binder 52 is Tx (° C.), it is preferable that the temperature be set to 0.6 Tx (° C.) or higher. This is because the higher the heating temperature is set, the softer the binder 52 becomes, whereas if the heat-resistance temperature is exceeded the structure of the binder 52 is destroyed, resulting in degradation of binder characteristics. Here, “heat-resistance temperature” is the temperature up to which the binder structure can be maintained, and in the case of resins refers to the melting point, whereas in the case of rubbers refers to the decomposition point at which cutting of rubber molecule chain and bridge portions (vulcanization) due to thermal degradation begins.

No particular limitations are imposed on the linear pressure during roller-pressing so long as the pressure is less than 100 kgf/cm, but it is preferable that the linear pressure be set as low as possible. This is because in roller-pressing while heating, no strong correlation appears between linear pressure and compression ratio (density of the polarizable electrode layer 18), and in order to reduce deformation of the collector 16 insofar as possible, it is preferable that the linear pressure be set as low as possible, or more specifically, be set to 50 kgf/cm or lower. The lower limit of the linear pressure is determined primarily by specifications of the roller-pressing portion 130; but a sufficiently high density is obtained even when the linear pressure is lowered to approximately 5 kgf/cm.

It is preferable that the speed during roller-pressing be set to 5 m/minute or less. This is because, if the roller-pressing speed is too high, heating of the polarizable electrode layer 18 is insufficient Because in the apparatus for manufacture of electrodes for electric double-layer capacitors of this aspect the coating, drying, and roller-pressing are performed continuously, if the roller-pressing speed is reduced, then the speeds of the other processes must also be reduced. Hence when there is a large difference between the maximum speed of the roller-pressing process and the maximum speeds of the other processes, prior to the roller-pressing process the stacked member may be taken up on a takeup roll, and the roller-pressing process then performed separately.

In this way, the compressed polar ale electrode layer 18 is formed on the collector 16, and the completed stacked member 20 is wound onto the takeup roll 102.

The above is the configuration of the first-stage portion 100. Next, the configuration of the second-stage portion 200 is explained.

As shown in (b) of FIG. 1, the second-stage portion 200 comprises an infrared ray drying portion 210. The infrared ray drying portion 210 comprises a drying chamber 211; an infrared ray lamp 212, provided within the drying chamber 211; a hot-air generator 213, which supplies hot air within the drying chamber 211; and, an exhaust tube 214, to exhaust gas within the drying chamber 211.

The stacked member 20, supplied from the feeder roll 201, passes through the interior of the drying chamber 211, and at this time is irradiated with infrared rays by the infrared ray lamp 212. By this means, the interior of the polarizable electrode layer 18 is heated, and the remaining solvent 54 is further evaporated During this period, hot air is supplied to the interior of the drying chamber 211 by the hot-air generator 213, and by this means evaporation of solvent 54 is promoted. The evaporated solvent 54 is removed to the outside of the drying chamber 211 via the exhaust tube 214. In this invention, it is not necessary that the gas supplied to the interior of the drying chamber 211 be hot air, but by supplying hot air, drying can be performed more efficiently.

As the heating temperature attained by the infrared ray lamp 212, it is preferable that as high a temperature as possible be set which is less than the heat-resistance temperature of the binder 52; specifically, when the heat-resistance temperature of the binder 52 is Tx (° C.), it is preferable that the temperature be set to 0.7 Tx (° C.). This is because the higher the heating temperature is set, the more evaporation of the solvent 54 is promoted, but if the heat-resistance temperature of the binder 52 is exceeded, then as described above, the structure of the binder 52 is destroyed, resulting in degradation of binder characteristics. At the time at which drying is performed by infrared ray irradiation, most of the solvent 54 has already been removed, and so bumping does not tend to occur even if the output of the infrared ray lamp 212 is raised.

From the standpoint of removing as much of the remaining solvent as possible, it is preferable that the time over which the stacked member 20 passes through the infrared ray drying portion 210 should be set to one hour or longer, and preferable to approximately three hours. Thus among the series of manufacturing processes, the process of drying by infrared ray irradiation takes longer than do other processes. In this aspect, the apparatus as a whole is separated into a first-stage portion 100 and a second-stage portion 200 for this reason. By thus separating processes which can be performed comparatively rapidly and processes which require time, production can be conducted more efficiently.

After this infrared ray drying, the collector 20 is taken up by the takeup roll 202.

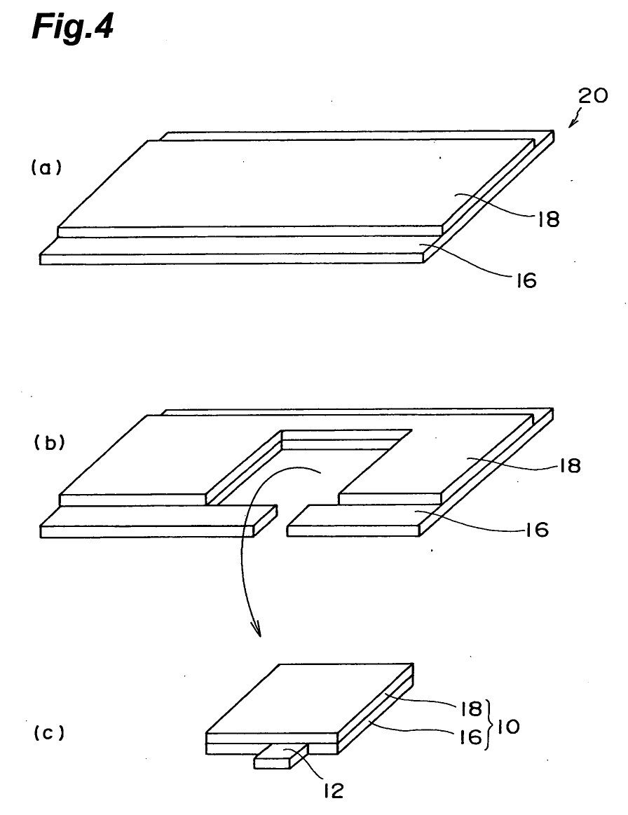

Then, as shown in (a) of FIG. 4, the stacked member 20 wound onto the takeup roll 102 is cut into a prescribed size, and as shown in (b) of FIG. 4, if the stacked member 20 is punched out according to the scale of the electric double-layer capacitors to be manufactured, then an electrode 10 for an electric double-layer capacitor is completed, as shown in (c) of FIG. 4. At this time, as shown in (c) of FIG. 4, if a portion of the collector 16 not covered by the polarizable electrode layer 18 is simultaneously drawn out, then this portion can be used as a drawn-out electrode 12.

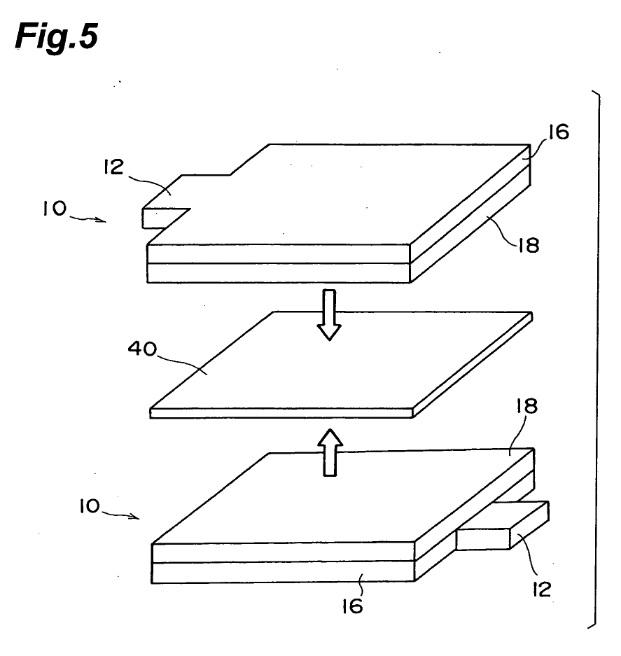

At least two electrodes 10 for an electric double-layer capacitor manufacture in this way are prepared, and are arranged with polarizable electrode layers 18 in opposition with the two electrodes 10 for an electric double-layer capacitor surrounding a separator 40, as shown in FIG. 5; this assembly is housed in a case, not shown, and the case interior is filled with an electrolytic solution, to complete the electric double-layer capacitor.

A separator 40 is a film which physically separates the polarizable electrode layers 18, 18, while enabling movement of electrolytic solution between the polarizable electrode layers 18, 18. It is preferable that separators 40 be formed from a porous insulating material; for example, a stacked member of films comprising polyethylene, polypropylene, or polyolefin, a stretched film of a mixture of the above resins, or, an unwoven cloth comprising at least one constituent component selected from among a group of cellulose, polyesters, and polypropylene, can be used. No limitations in particular are placed on the thickness of separators 40, but it is preferable that the thickness be 15 μm or greater but 200 μm or less, and more preferably still 30 μm or greater but 100 μm or less.

As the electrolytic solution, a well-known electrolytic solution (electrolytic aqueous solution, or electrolytic solution using an organic solvent) employed in electric double-layer capacitors can be used However, because electrochemically the decomposition voltage of the electrolytic solution used in the electrode double-layer capacitor is low, the withstand voltage of the capacitor is limited to a low value, and so it is preferable that an electrolytic solution using an organic solvent (a non-aqueous electrolytic solution) be used. No limitations in particular are placed on the specific type of electrolytic solution, but it is preferable that the electrolytic solution be selected taking into consideration the solubility of the solute, degree of dissociation, and viscosity of the liquid; and it is particularly desirable that the electrolytic solution have high conductivity and a high potential window (high decomposition initiation voltage). As representative examples, quaternary ammonium salts, such as tetraethyl ammonium tetrafluoroborate, dissolved in an organic solvent such as propylene carbonate, diethylene carbonate, or acetonitrile, are used. In this case, intermixing of water must be rigorously controlled

As explained above, in the apparatus for manufacture of electrodes for electric double-layer capacitors of this aspect, drying to remove the solvent 54 is divided into two operations, and after first performing hot-air drying, infrared ray drying is performed. By this means, high-quality electrodes for electric double-layer capacitors can be produced efficiently. That is, there is no long occurrence of unevenness in the distribution of binder due to solvent movement, as when performing only hot-air drying, nor is there destruction of the coated film due to bumping, as happened when performing i ray drying in a state of comprising a large amount of solvent Moreover, there is no longer a need to perform batch processing using a vacuum oven, so that productivity can be improved.

Further, in this aspect roller-pressing is performed while heating the polarizable electrode layer 18, and so the binder 52 binding the activated carbon or other porous particles 50 is softened, and can easily permeate into the fine holes of the porous particles 50. As a result, even under low-pressure pressing at less than 100 kgf/cm, the density of the polarizable electrode layer 18 can be greatly increased. By this means, wrinkles occurring in the collector can be markedly suppressed

In the above, a preferred aspect of the invention has been explained; however, this invention is not limited to the above aspect, and various modifications are possible without deviating from the gist of the invention; of course such modifications are included in the scope of the invention.

For example, in the above aspect, the process of coating by the coating portion 110, the hot-air drying process by the hot-air drying portion 120, and the roller-pressing process by the roller-pressing portion 130 are collected in the first-stage portion 100, by which means these processes are performed continuously; but continuous performance of these processes is not necessary in this invention. Hence when there is a large difference between the maximum speed of a certain process and the maximum speed of another process, material can be taken up by a takeup roll between these processes, and used separately in the next process.

Further, in the above aspect after performing roller-pressing using the roller-pressing portion 130, infrared ray drying is performed by the infrared ray drying portion 210; but the order may be reverse

Further, in addition to use as an electrode in an electric double-layer capacitor, an electrode for electrochemical capacitors manufactured by means of this invention can also be used as an electrode in pseudo-capacity capacitors, pseudo-capacitors, redox capacitors, and various other kinds of electrochemical capacitors.

### Embodiments

Below, embodiments of the invention are explained; however, the invention is not limited to these embodiments.

### Embodiment 1

As the porous particles used in the coating liquid, 90 parts by weight particle-shape activated carbon (Kuraray Chemical Co., Ltd, product name RP-20) and, as a conductive agent, one part by weight acetylene black (Denki Kagaku Kogyo KK, product name Denka Black), were mixed for 15 minutes using a planetary dispersion mill. To this total mix amount were added 9 parts by weight polyvinylidene fluoride (PVDF), as a binder, and 100 parts by weight NMP (n-methyl-2-pyrolidone), as a solvent (solid portion concentration: approximately 50%), and a planetary dispersion mill was used to perform kneading for 45 minutes. Then, 140 parts by weight NMP (n-methyl-2-pyrolidone) were added to the kneaded material, as solvent (solid portion concentration: approximately 30%), and by srring for four hours, the coating liquid was prepared.

Next, the prepared coating liquid was used to coat aluminum foil (thickness 40 μm) which was the collector using an extrusion nozzle method, and by drying for five minutes in a hot-air drying furnace at 120° C., a stacked member of thickness 300 μm was formed. The amount of solvent remaining after the hot-air drying was 35%, takng 100% to be the amount immediately after coating.

Then, after being subjected to hot-air drying, the stacked member was irradiated with infrared rays, and further drying was performed. Infrared ray drying was performed for one minute at a temperature of 175° C., while applying hot air. By this means, an electrode sheet sample of Embodiment 1 was obtained.

Upon measuring the amount of solvent remaining in the electrode sheet sample of Embodiment 1, for an amount immediately after coating of 100%, the value was found to be 0.7%, which is satisfactory.

### Embodiment 2

Except for setting the time for performing infra ray drying to three hours, the electrode sheet sample of Embodiment 2 was fabricated in the same was as that of Embodiment 1. Upon measuring the amount of solvent remaining in the electrode sheet sample of Embodiment 2, for an amount immediately after coating of 100%, the value was found to be 0.1%, which is extremely satisfactory.

### COMPARATIVE EXAMPLE 1

In place of infrared ray drying, a vacuum oven was used to perform drying for 15 hours; otherwise, the electrode sheet sample of Comparative Example 1 was fabricated in the same way as that of Embodiment 1. The temperature within the vacuum oven was set to 175° C. Upon measuring the amount of solvent remaining in the electrode sheet sample of Comparative Example 1, for an amount immediately after coating of 100%, the value was found to be 0.6%, which is satisfactory. However, an extremely long time (15 hours) was required for drying using the vacuum oven.

### COMPARATIVE EXAMPLE 2

Other than reversing the order of the hot-air dying and the infrared ray drying, the electrode sheet sample of Comparative Example 2 was fabricated in the same way as that of Embodiment 1. As a result, bumping occurred due to the infrared ray drying which was performed first, and substantial roughness appeared on the surface of the coated film.

What is claimed is:

1. A method of manufacturing electrodes for electrochemical capacitors, comprising:
a fist step of forming, on a collector, a coated film comprising porous particles, a binder which binds said porous particles, and a solvent which dissolves said binder,
a second step of forming a polarizable electrode layer by hot-air drying of said coated film; and
a third step of infra ray drying of said polarizable electrode layer.

2. The method of manufacturing electrodes for electrochemical capacitors according to claim 1, wherein
said third step is performed by irradiating said polarizable electrode layer with infrared rays wile applying hot air to said polarizable electrode layer.

3. The method of manufacturing electrodes for electrochemical capacitors according to claim 1, further comprising a fourth step of roller-pressing of said polarizable electrode layer after said second step and before said third step.

4. The method of manufacturing electrodes for electrochemical capacitors according to claim 3, wherein
said first step, said second step, and said fourth step are performed continuously.

5. The method of manufacturing electrodes for electrochemical capacitors according to claim 3, wherein
said fourth step is a step of performing roller-pressing at a linear pressure of less than 100 kg/cm while heating said polarizable electrode layer.

6. An apparatus for manufacturing electrodes for electrochemical capacitors, comprising:
coating means for forming, on a collector, a coated film comprising porous particles, a binder which binds said porous particles, and a solvent which dissolves said binder,
hot-air dying means for forming a polarizable electrode layer by hot-air drying of said coated film; and
infrared drying means for performing infrared ray drying of said polarizable electrode layer.
